(19) United States
(12) Patent Application Publication
(10) Pub. No.: US 2023/0058632 A1
(43) Pub. Date: Feb. 23, 2023

(54) APPARATUS AND METHOD TO FACILITATE MODELING RESPONSES TO VARIABLE VALUES

(71) Applicant: Walmart Apollo, LLC, Bentonville, AR (US)

(72) Inventors: Anbu Aaron Ajay Ullas, Farmers Branch, TX (US); Ehsan Nazarian, Rogers, AR (US); Haining Liu, Dallas, TX (US); Pingjian Yu, Plano, TX (US); Ketan Mudda, Bentonville, AR (US); Sara Amin, Dallas, TX (US); Zekun Li, Austin, TX (US)

(21) Appl. No.: 17/404,329

(22) Filed: Aug. 17, 2021

(51) Int. Cl. G06N 3/08; G06N 3/04

(52) U.S. Cl. CPC G06N 3/08; G06N 3/0454; G06N 3/0427

(57) ABSTRACT

Particular data is selected from a members-based dataset to provide a resultant training corpus. A first neural network receives that training corpus and generates a first trained machine learning model. That first trained machine learning model can predict member engagement score values for each of a plurality of candidate variable values. The aforementioned training corpus can also be provided to a second neural network to generate a second trained machine learning model. That second trained machine learning model can then be used to predict member engagement score values for each of a plurality of initial-state variable values. The aforementioned member engagement score values for each of the plurality of candidate variable values can then be consolidated with the member engagement score values for each of a plurality of initial-state variable values to thereby provide resultant consolidated member engagement score values.

### TECHNICAL FIELD

These teachings relate generally to machine learning.

### BACKGROUND

Various services and/or access to items or information may be provided on a membership basis. Whether or not a given member renews their membership provides strong feedback regarding their overall satisfaction. For example, a member who concludes that they are paying too much for certain items may respond by failing to renew their membership.

Unfortunately, renewal opportunities are typically infrequent. For example, many memberships are renewed on an annual basis. Slowness and infrequency of that renewal information therefore renders that information cumbersome and difficult to use in practice and especially difficult to correlate to any particular driver. More specifically, and as a specific illustrative example, it can be relatively difficult to associate the cost of various services/items with a given decision to not renew such a membership.

### BRIEF DESCRIPTION OF THE DRAWINGS

The above needs are at least partially met through provision of the method and apparatus to facilitate modeling responses to variable values described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a flow diagram as configured in accordance with various embodiments of these teachings;

FIG. 4 comprises a process overview as configured in accordance with various embodiments of these teachings;

FIG. 5 comprises a layer-based overview as configured in accordance with various embodiments of these teachings; and

FIG. 6 comprises a layer-based overview as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments provide for facilitating modeling responses to variable values. By one approach, these teachings provide for a members-based dataset and for selecting particular data from that dataset to provide a resultant training corpus. A first neural network receives that training corpus and generates a first trained machine learning model. This first neural network can be configured as a feed-forward natural-language-processing neural network. These teachings provide for using that first trained machine learning model to predict member engagement score values for each of a plurality of candidate variable values.

These teachings are highly flexible in practice and will accommodate a members-based data set comprising a variety of different kinds of information. Examples include, but are not limited to, item-level metadata, item-level transaction data, promotions data, holiday data, physical facilities metadata, weather data, and anonymized demographic data. By one approach, selecting particular data from this data set to provide the aforementioned training corpus comprises, at least in part, identifying top items for each of a plurality of the members and providing member engagement score data corresponding to a predetermined period of time. Top item prices for that predetermined period of time are identified, and these teachings will also accommodate providing member renewal data and duration-of-membership data.

By one approach, these teachings can further provide for providing the aforementioned training corpus to a second neural network to generate a second trained machine learning model. That second neural network may be configured, for example, as a fee-forward neural network that employs weighting of training data points (via, for example, XGBoosting). That second trained machine learning model can then be used to predict member engagement score values for each of a plurality of initial-state variable values. In such a case, these teachings can then further provide for consolidating the aforementioned member engagement score values for each of the plurality of candidate variable values with the member engagement score values for each of a plurality of initial-state variable values to thereby provide resultant consolidated member engagement score values.

By one approach, these teachings can further provide for generating an objective function based, at least in part, on the aforementioned consolidated member engagement score values and then optimizing that objective function (using, for example, multi-objective optimization). So configured, these teachings can support, for example, optimizing product pricing as a function of both unit sales and increased member engagement scores. As one example in these regards, these teachings will permit the assignment of a budget and a corresponding time period for a given membership-based retail establishment and these teachings will facilitate determining optimum product prices for that time period. By one approach, these teachings can predict sales of a given product in a given week in a given member-based retail sales facility. These teachings will also accommodate use of natural language processing tools to predict complementary and substituted product sales based upon the contents of member's baskets. Generally speaking, the aforementioned approaches model complex non-linear functions as being linear in order to simplify solution and processing times.

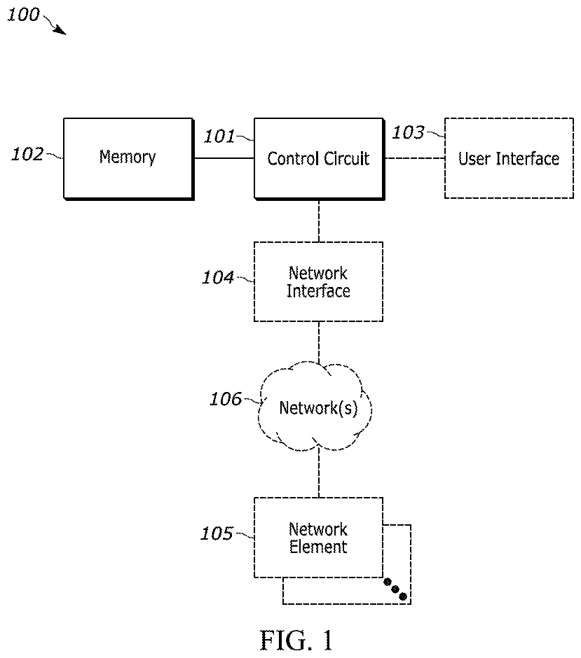

These and other benefits may become clearer upon making a thorough review and study of the following detailed description. Referring now to the drawings, and in particular to FIG. 1, an illustrative apparatus 100 that is compatible with many of these teachings will first be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

The control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to the aforementioned members-based database information, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

By one optional approach, the control circuit 101 operably couples to a user interface 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

In another optional approach, in lieu of the foregoing or in combination therewith, the control circuit 101 operably couples to a network interface 104. So configured, the control circuit 101 can communicate with other network elements 105 (both within the apparatus 100 and external thereto) via the network interface 104 (and any intervening communications/data networks 106 such as, but not limited to, the Internet). Numerous examples of such interfaces are known in the art. A non-exhaustive listing would include Universal Serial Bus (USB)-based interfaces, RS232-based interfaces, I.E.E.E. 1394 (aka Firewire)-based interfaces, Ethernet-based interfaces, any of a variety of so-called Wi-Fi′-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces.

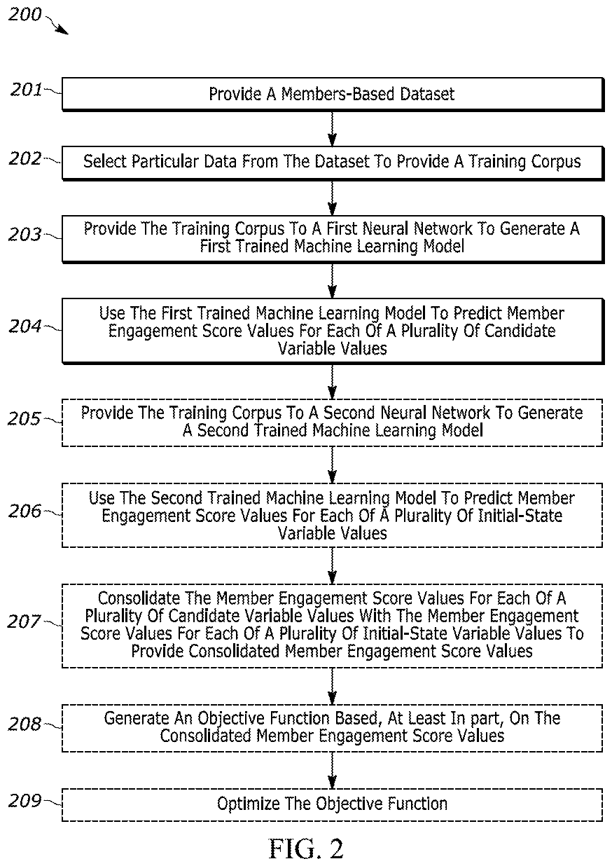

Referring now to FIG. 2, a process 200 that comports with many of these teachings will be described.

At block 201, this process 200 provides a members-based data set. This members-based data set can reside, for example, in the aforementioned memory 102. The specific contents of this members-based data set can vary with the application setting. Examples include, but are not limited to:
item-level metadata;
item-level transaction data;
promotions data;
holiday data;
physical facilities metadata;
weather data; and
anonymized demographic data.

By one approach, the members-based data set comprises at least three of the aforementioned items. By another approach, the members-based data set comprises at least four or five of the aforementioned items. By yet another approach, the members-based data set includes all of the aforementioned items.

The availability and use of such members-based data can be strictly limited based on the specific permissions provided by the members themselves and/or as may be otherwise limited by local laws and regulations.

The aforementioned members-based data set can be sourced in any of a variety of ways. By one approach, at least some of the aforementioned network elements 105 are associated with corresponding members-based retail establishments. (As used herein, the expression “members-based” will be understood to refer to an establishment that limits entry and/or the ability to conduct transactions to persons or entities that are recognized members of that establishment. Common examples in the United States include Sam's Club and Costco facilities.) So configured, these network elements 105 can source some or all of the aforementioned information at least for their own respective establishment. In such a case, the members-based data set can accordingly represent information corresponding to a plurality of different physical establishments.

By one approach, some or all of the aforementioned information is pushed to the memory 102. By another approach, in lieu of the foregoing or in combination therewith, some or all of the aforementioned information is pulled to the memory 102. Whether pushed and/or pulled, the gathering of such information can occur in a segregated manner over time or may represent an acquisition of an aggregated data set (i.e., pursuant to a batched protocol).

At block 202, this process 200 provides for selecting particular data from the aforementioned data set to thereby provide a training corpus. These teachings will accommodate a variety of approaches and criteria by which such data is selected.

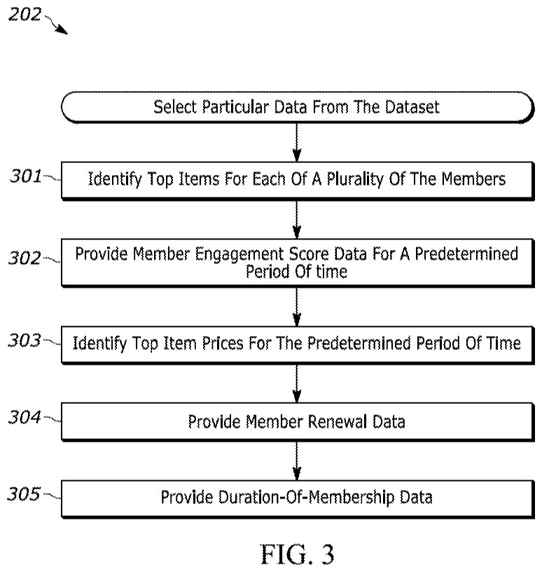

Referring to FIG. 3, one illustrative example as regards the selection of particular data from the data set now be described. It will be understood that the specific details in this example are intended to serve an illustrative purpose and are not intended to suggest any particular limitations as regards these teachings.

In this example, at block 301, top items (i.e., those items selected most often) are identified for each of a plurality of the corresponding group of members. By one approach, these may be the members of only a given store, or may be members for an aggregation of a plurality of stores. When identifying top items, the identification process may be constrained to a particular beginning date and end date. These teachings will also accommodate other filtering approaches. For example, only the top items for certain product categories may be so identified. In that case, items for excluded product categories can be ignored notwithstanding having been frequently selected by the membership.

At block 302, this process provides for providing member engagement score data for a predetermined period of time (such as the previous week, month, year, or other duration of time of interest). A member engagement score is a value (such as an integer) that represents a member's intent to renew. Viewed another way, the member engagement score is a proxy for an intent to renew. For a given scale or range, such as a range of integers from 1 to 10, higher values can represent a higher likelihood of intent to renew and vice versa.

At block 303, this process provides for identifying the top item prices (i.e., the most expensive prices) for a predetermined period of time (which may be the same as, or different than, the foregoing predetermined period of time). This may comprise, for example, identifying the 10 highest prices, the 100 highest prices, or the like as desired.

At block 304, this process provides for providing member renewal data. This data can comprise, for example, information regarding a percent rate (or other relevant metric) at which existing members renewed their membership over a predetermined period of time. Such information may also indicate, for example, whether a renewal that occurred during the predetermined period of time represents a first renewal, a second renewal, and so forth. This renewal information may or may not be correlated to shopping activity for the corresponding members.

And at block 305 in this example, the selection of particular data from the data set can include duration-of-membership data. This data can comprise, for example, information that represents how long various members, or groups of members, have continuously maintained their membership.

Referring again to FIG. 2, at block 203 this process 200 provides the foregoing training corpus to a first neural network to generate a corresponding first trained machine learning model. By one approach, this first neural network comprises the aforementioned control circuit 101 configured as a feed-forward natural-language-processing neural network. Such neural networks are known in the art. Accordingly, no further elaboration in these regards is provided here for the sake of brevity.

At block 204, this process 200 provides for using the aforementioned first trained machine learning model to predict member engagement score values for each of a plurality of candidate variable values. These teachings will accommodate a variety of different variables. Useful examples include, but are not limited to, a variety of different candidate prices (as versus current actual prices) for any of the top 10 items that are frequently shopped by a given member over a given period of time. Accordingly, it can be seen that the first trained machine learning model predicts a likelihood of a given member renewing their membership for a variety of different shopping circumstances representing, at least in part, their favorite items at various price points.

Those skilled in the art will recognize the value of such information. In addition, these teachings are highly flexible in practice and will accommodate not only modifications to the foregoing but supplemental activity as well. For example, and with continued reference to FIG. 2, at optional block 205, this process 200 provides the aforementioned training corpus to a second neural network to thereby generate a second trained machine learning model. This second neural network can comprise configuring the aforementioned control circuit 101 as a feed-forward neural network that employs weighting of training data points. Such weighting can be effected via XGBoosting. Generally speaking, XGBoost works as newton raphson in function space. The applicant has determined that XGBoost provides a regularizing gradient boosting framework that can be beneficially applied in the current context.

At optional block 206, these teachings then provide for using the aforementioned second trained machine learning model to predict member engagement score values for each of a plurality of initial-state variable values. By one approach, these initial-state variable values can constitute, for example, current selling prices for the items of interest.

At optional 207, this process 200 can then provide for consolidating the member engagement score values for each of a plurality of candidate variable values as predicted by the first trained machine learning model with the member engagement score values for each of a plurality of initial-state variable values as predicted by the second trained machine learning model to thereby provide consolidated member engagement score values.

At optional block 208, this process then can provide for generating an objective function based, at least in part, on the consolidated member engagement score values. Those skilled in the art will understand that an objective function typically comprises a loss function that is to be minimized (or the negative of a loss function, in which case maximization is sought) via optimization. With that in mind, optional block 209 provides for optimizing that objective function using, for example, multi-objective optimization (sometimes referred to as multi-criteria optimization).

[Note to inventors—can you provide a sentence or two to summarize precisely what it is that one gets at the conclusion of optimizing that objective function?]

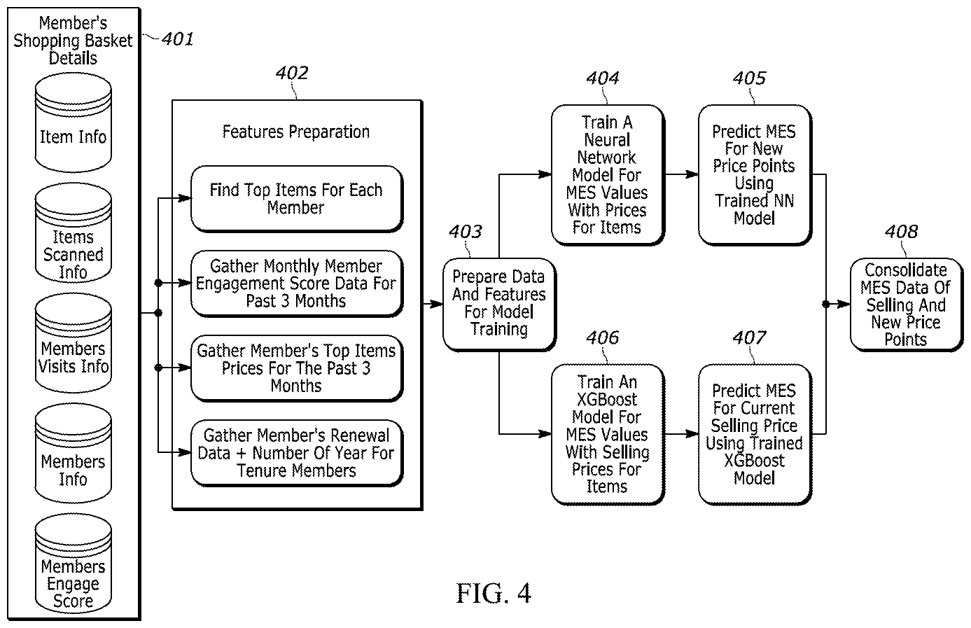

FIG. 4 provides an illustrative particular example in accord with these teachings. Again, the specific details of this example are intended to serve an illustrative purpose and are not intended to suggest any particular limitations with respect to these teachings.

As denoted at reference numeral 401, various details regarding members' shopping basket details are provided. In this example these details include information regarding specific items, information gleaned from item scans, information regarding members' visits, members' demographic information, and members' engagement scores. Features are then prepared at reference numeral 402. In this example, these features include finding the top items for each member, gathering monthly member engagement score data for a preceding three months, gathering members' top items prices for the past three months, and gathering members' renewal data and aggregate number of years for previously-renewed members.

The foregoing data and features are then prepared 403 for model training. At reference numeral 404 a first neural network model is trained to predict member engagement score values at various prices for various items. At reference numeral 405 that then serves to predict member engagement scores for new price points.

At reference numeral 406 an XGBoost model is trained using the aforementioned data and features to predict member engagement score values for corresponding selling prices for the aforementioned items. At reference numeral 407 the latter neural network model then serves to predict member engagement scores for current selling prices.

Finally, at reference numeral 408, the aforementioned predicted member engagement scores for current selling prices and alternative selling prices are consolidated.

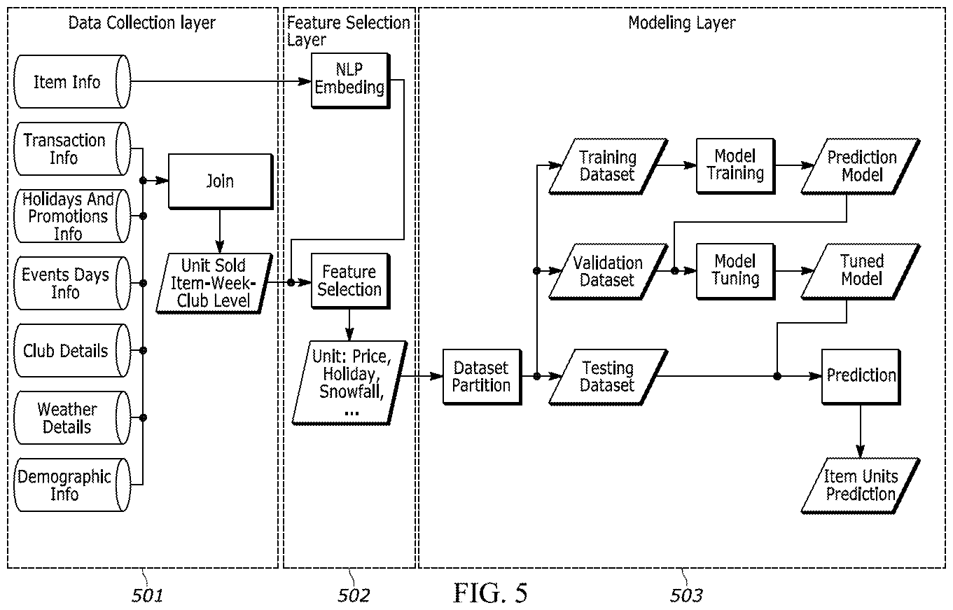

FIG. 5 represents the foregoing as a data collection layer 501, a feature selection layer 502, and a modeling layer 503.

In some application settings, it can be helpful to further take into account items that can be substitutes for selected items and/or items that may be complementary to one another (i.e., one or more items that may likely be selected if a particular first item is selected). Generally speaking, two items A and B are substitutes if they interact similarly to one another in comparison with other items in the club:
P(*−|Item A)≈P(*−|Item B)

A complementary score for item pair {A, B} can be defined as:
½ (P(Item A−|Item B)+P(Item B−|Item A)

In such a case, the foregoing predictions may not only account for the specifically identified items, but also items that can be reasonably substituted for such items. Similarly, if desired, complementary items might be used in either the same way or as part of the process of selecting the particular items upon which the foregoing analysis focuses.

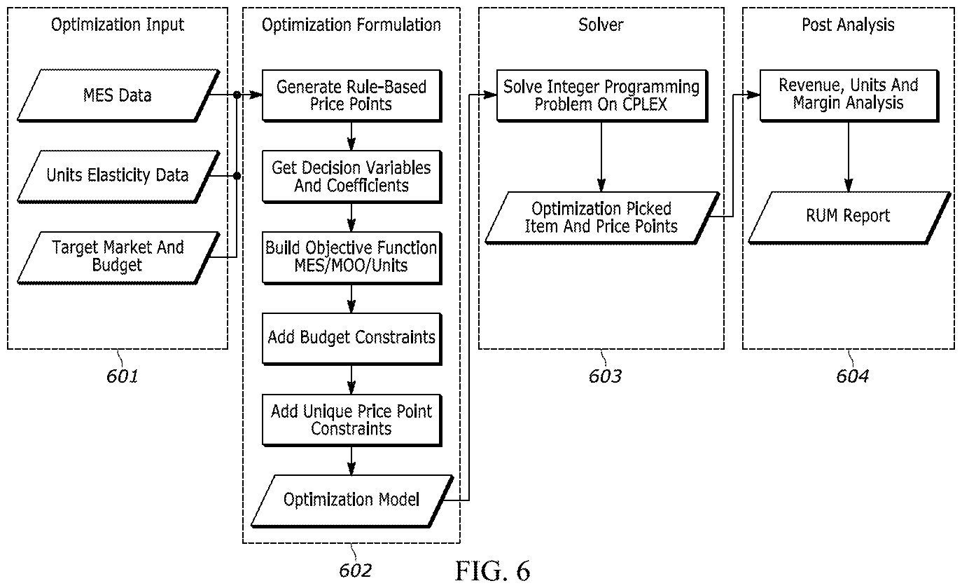

FIG. 6 provides a more detailed illustrative example pertaining to the aforementioned optimization activity. Again, the details of this example are not intended to express any specific limitations with respect to these teachings. FIG. 6 represents this activity via an optimization input layer 601, an optimization formulation layer 602, a solver layer 603, and a post analysis layer 604.

The optimization input layer 601 provides for receipt of the member engagement score data, elasticity data regarding the units of interest, and information regarding the target market and any corresponding financial budget.

The optimization formulation layer 602 provides for generating rule-based price points based upon the foregoing input. Next, this layer provides for obtaining decision variables and coefficients and then building the objective function. Budget constraints (based upon the input budget information) can then be added along with any unique price point constraints applicable to the application setting. The resultant optimization model then passes to the solver layer 603.

The solver layer 603 solves the corresponding integer programming problem using, in this example, the IBM ILOG CPLEX Optimization Studio as is known in the art. The corresponding optimization results in picked items and corresponding price points.

The post analysis layer 604 then provides for corresponding analysis of resultant predicted revenue, units, and margin and yields a resultant report in those regards.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. An apparatus to facilitate modeling responses to variable values, the apparatus comprising:
a memory having a member-based dataset stored therein;
a control circuit operably coupled to the memory and configured to:
select particular data from the dataset to provide a training corpus;
provide the training corpus to a first neural network to generate a first trained machine learning model; and
use the first trained machine learning model to predict at least one member engagement score value for each of a plurality of candidate variable values.

2. The apparatus of claim 1 wherein the control circuit is configured to select particular data from the dataset to provide a training corpus by, at least in part:
identifying top items for each of a plurality of the members;
providing member engagement score data for a predetermined period of time;
identifying top item prices for the predetermined period of time;
providing member renewal data; and
providing duration-of-membership data.

3. The apparatus of claim 1 wherein the first neural network is configured as a feed-forward natural-language-processing neural network.

4. The apparatus of claim 1 wherein the control circuit is further configured to:
provide the training corpus to a second neural network to generate a second trained machine learning model; and
use the second trained machine learning model to predict member engagement score values for each of a plurality of initial-state variable values.

5. The apparatus of claim 4 wherein the second neural network is configured as a feed-forward neural network and employs weighting of training data points.

6. The apparatus of claim 4 wherein the control circuit is configured to:
consolidate the member engagement score values for each of a plurality of candidate variable values with the member engagement score values for each of a plurality of initial-state variable values to provide consolidated member engagement score values.

7. The apparatus of claim 6 wherein the control circuit is configured to:
generate an objective function based, at least in part, on the consolidated member engagement score values.

8. The apparatus of claim 7 wherein the control circuit is configured to:
optimize the objective function.

9. The apparatus of claim 8 wherein the control circuit is configured to optimize the objective function by using multi-objective optimization.

10. A method to facilitate modeling responses to variable values, the method comprising:
providing a members-based dataset;
selecting particular data from the dataset to provide a training corpus;
providing the training corpus to a first neural network to generate a first trained machine learning model; and
using the first trained machine learning model to predict member engagement score values for each of a plurality of candidate variable values.

11. The method of claim 10 wherein the members-based dataset comprises, at least in part, at least three of:
item-level metadata;
item-level transaction data;
promotions data;
holiday data;
physical facilities metadata;
weather data; and
anonymized demographic data.

12. The method of claim 10 wherein selecting particular data from the dataset to provide a training corpus comprises, at least in part:
identifying top items for each of a plurality of the members;
providing member engagement score data for a predetermined period of time;
identifying top item prices for the predetermined period of time;
providing member renewal data; and
providing duration-of-membership data.

13. The method of claim 10 wherein the first neural network is configured as a feed-forward natural-language-processing neural network.

14. The method of claim 10 further comprising:
providing the training corpus to a second neural network to generate a second trained machine learning model; and
using the second trained machine learning model to predict member engagement score values for each of a plurality of initial-state variable values.

15. The method of claim 14 wherein the second neural network is configured as a feed-forward neural network and employs weighting of training data points.

16. The method of claim 15 wherein the second neural network employs weighting of training data points via xgboosting.

17. The method of claim 14 further comprising:
consolidating the member engagement score values for each of a plurality of candidate variable values with the member engagement score values for each of a plurality of initial-state variable values to provide consolidated member engagement score values.

18. The method of claim 17 further comprising:
generating an objective function based, at least in part, on the consolidated member engagement score values.

19. The method of claim 18 further comprising:
optimizing the objective function.

20. The method of claim 19 wherein optimizing the objective function comprises using multi-objective optimization.
